(19) United States
(12) Patent Application Publication
(10) Pub. No.: US 2007/0072084 A1
(43) Pub. Date: Mar. 29, 2007

(54) Nonaqueous electrolyte secondary battery

(76) Inventor: Katsushi Nishie, Kyoto-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/574,952

(22) PCT Filed: Oct. 6, 2004
(86) PCT No.: PCT/JP04/15097

§ 371 Date: Apr. 7, 2006

(30) Foreign Application Priority Data
Oct. 7, 2003 (JP) 2003-348134

(51) Int. Cl. H01M 10/40; H01M 4/58

(52) U.S. Cl. 429/324; 429/218.1; 429/232; 429/199

(57) ABSTRACT

A nonaqueous electrolyte secondary battery which has a negative electrode including silicon-containing material, in which the battery has a nonaqueous electrolyte solution and the nonaqueous electrolyte solution includes a phosphazene derivative.

### TECHNICAL FIELD

The present invention relates to nonaqueous electrolyte secondary batteries which has a negative electrode including silicon-containing material.

### BACKGROUND ART

Small and lightweight nonaqueous electrolyte secondary batteries have been widely used recently as a power source for mobile phones, PDAs, digital cameras and the like, and the energy density thereof is expected to improve. In the nonaqueous electrolyte secondary battery which has been practically applied these days, typically, carbon material is used as negative active material and lithium transition metal oxide as positive active material.

However, since the utilization factor of the negative electrode using carbon material has almost reached its theoretical capacity, it would be difficult to improve battery discharge capacity in the future by 10% or higher without changing the weights of the active materials used for the positive and negative electrodes.

Consequently, there has been an increase in research into materials having a larger discharge capacity, to be substituted for carbon material, as follows: a technology using single-crystal silicon is disclosed in Japanese Patent Publication No. H05-74463A; a technology using amorphous silicon in Japanese Patent Publication No. H07-29602A; a technology using silicon particles in Japanese Patent Publication No. 2000-12014A; and a technology using a compound including silicon atoms in No. 2000-3727A.

### DISCLOSURE OF THE INVENTION

When using a material such as silicon as negative active material, the battery can have increased capacity and energy density. However, as described on p 236 of Treatise on Inorganic Chemistry (Muki-kagaku-zensyo) (XII-2, Iwaji IWASAKI, Maruzen, July 1986), since silicon reacts with hydrogen fluoride to produce hydrogen (Si+4HF═SiF₄+2H₂), in a nonaqueous electrolyte secondary battery using silicon as negative active material, the produced gas swells the battery when left under high temperature conditions.

Accordingly, the present invention is made in order to solve the above problem, and it is an object of the present invention, in a nonaqueous electrolyte secondary battery using a material such as silicon as negative active material, to suppress the swelling of the battery when left under high temperature conditions.

A first aspect of the present invention is a nonaqueous electrolyte secondary battery which is characterized by having a negative electrode including silicon-containing material, in which the nonaqueous electrolyte solution includes a phosphazene derivative.

The nonaqueous electrolyte secondary battery according to the present invention is characterized by having a negative electrode including silicon-containing material, in which the nonaqueous electrolyte solution includes a phosphazene derivative. The present invention can suppress the swelling of a battery when left under high temperature conditions in the nonaqueous electrolyte secondary battery which uses a negative electrode including silicon-containing material.

### PREFERRED MODE FOR CARRYING OUT THE INVENTION

A nonaqueous electrolyte secondary battery according to the present invention suppresses the swelling of a battery when left under high temperature conditions, by having a negative electrode including silicon-containing material where the nonaqueous electrolyte solution includes a phosphazene derivative.

As a silicon-containing material included in the negative electrode according to the present invention, at least one material selected from the group consisting of silicon, silicon oxide, silicon nitride, silicon sulfide and silicon alloy can be used.

As a phosphazene derivative contained in the nonaqueous electrolyte solution according to the present invention, not being limited to a specific one, the chain phosphazene derivative represented by the following general formula (Chemical Formula 1) or the cyclic phosphazene derivative represented by the following second general formula (Chemical Formula 2) can be used independently or by mixture.

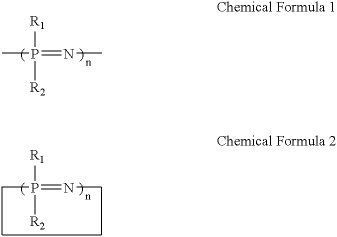

It should be noted that reference characters R₁ and R₂ mean a monovalent substituent or halogen element and n means an integer from 3 through 10 in Chemical Formula 1 and Chemical Formula 2. All of the elements corresponding to R₁ and R₂ maybe substituents of the same kind, or some thereof may be a different substituent.

By containing a phosphazene derivative in nonaqueous electrolyte solution, the swelling of the nonaqueous electrolyte battery can be suppressed when the battery is left under high temperature conditions. Although the reason therefor remains unclear, it is conceivable that a phosphazene derivative reacts with silicon to form a stable film, thereby suppressing the reaction of the halogen element with the silicon present in the nonaqueous electrolyte solution.

In the phosphazene derivative contained in the nonaqueous electrolyte solution according to the present invention, represented by Chemical Formula 1 or 2, when the substituent R is a halogen element, it is preferable to use fluorine, chlorine, bromine or the like. Among these elements, fluorine is particularly preferable.

When the substituent R is a monovalent substituent, the examples thereof include a hydrogen atom, an alkoxy group, an alkyl group, carboxyl group, acyl group and aryl group. Among these substituents, an alkoxy group is preferable. Examples of the alkoxy group include a methoxy group, an ethoxy group, a propoxy group, a butoxy group; and an alkoxide-substituted alkoxy group such as a methoxyethoxy group and a methoxyethoxyethoxy group. For R, among these alkoxy groups, a methoxy group, an ethoxy group, a methoxyethoxy group or a methoxyethoxyethoxy group is preferable. A methoxy group or an ethoxy group is more preferable. Furthermore, the hydrogen in the above monovalent substituent R is preferably substituted by a halogen element such as fluorine.

Examples of the alkyl group include a methyl group, an ethyl group, a propyl group, a butyl group and a pentyl group. Examples of the acyl group include a formyl group, an acetyl group, a propiony group, a butyryl group, an isobutyryl group and a valeryl group. Examples of the aryl group include a phenyl group, a tolyl group and a naphthyl group.

In the nonaqueous electrolyte solution, the proportion of the phosphazene derivative relative to the total mass of the phosphazene derivative and the nonaqueous electrolyte solution is preferably 0.1 to 60 mass % and more preferably 0.1 to 30 mass %. When the total mass is smaller than the range, the swelling is suppressed less effectively. When larger than the range, a reaction product is decomposed thereby deteriorating the effect of suppressing the swelling.

Examples of the silicon-containing material contained in the negative electrode according to the present invention include the following materials. Silicon. Materials represented by SiOₓ (0≦x<2) as a silicon oxide. As a silicon alloy, materials in which silicon contains one or more kinds of the flowing elements: typical nonmetallic elements such as B, N, P, F, Cl, Br and I; typical metallic elements such as Li, Na, Mg, Al, K, Ca, Zn, Ga, Ge; and transition metallic elements such as Sc, Ti, V, Cr, Mn, Fe, Co, Ni, Cu, Mo, Zr, Ta, Hf, Nb and W, SiN, Si₂N₂, Si₃ N₄, Si₂ N₃ as a silicon nitride. Silicon monosulfide, silicon disulfide or the like as silicon sulfide.

These silicon-containing materials can be used independently or by mixture. Among these materials, in the materials represented by SiOₓ (0≦x<2), it is preferable to use a material including both phases of Si and SiOₓ (1<x≦2). Furthermore, in the X-ray diffraction pattern using the CuKα rays of the relevant material, at least either of the half value widths of the diffraction peak in the Si (111) plane and in the Si (220) plane is preferably less than 3°.

The structure of the silicon-containing material may be from crystalline through amorphous. An amorphous silicon-containing material is particularly preferable.

In the present invention, when a silicon-containing material is set to A, Material C in which Material A has Conductive Material B; and Material E in which particles composed of a mixture of Material A and Carbon Material D having Conductive Material B can be used.

Examples of Conductive Material B include Cu, Ni, Ti, Sn, Al, Co, Fe, Zn, Ag; an alloy of two or more kinds thereof; and a carbon material. Among the materials, it is preferable to use a carbon material. Furthermore, at least a portion of the surface of the particles composed of Material A or a mixture of Material A and Carbon Material D is preferably coated with carbon material.

Examples of a coating method with carbon material include chemical vapor deposition in which benzene, toluene, xylene, methane, acetylene or the like is decomposed in a vapor phase as a carbon source so as to be evaporated onto the surface of the particles chemically; a method by calcination after mixing with a thermoplastic resin such as pitch, taror and furfuryl alcohol; and a method using mechanochemical reaction which makes mechanical energy act between particles and carbon material so as to form a complex. Among these methods, chemical vapor deposition is preferably used because carbon material can be coated uniformly.

In Material C in which the abovementioned Silicon-Containing Material A has Conductive Material B, the amount of the coated Conductive Material B is preferably 1 to 30 mass % relative to the mass of Material C as a whole. Furthermore, 10 to 20 mass % is more preferable. If the amount is smaller than the range, enough conductivity cannot be ensured so that cycle performance becomes inferior. If larger than the range, a large discharge capacity cannot be obtained.

The number average particle diameter of Material C is preferably 0.1 to 20 μm. If the number average particle diameter is smaller than the range, Material C becomes difficult to manufacture and handle. If the average particle diameter is larger than the range, it becomes difficult to prepare a negative electrode plate. It should be noted that the average particle diameter of the particles means the number average value obtained by laser diffractometry.

In Material E in which particles composed of a mixture of Silicon-Containing Material A and Carbon Material D have Conductive Material B, the amount of the coated Conductive Material B is preferably 1 to 30 mass % relative to the mass of Material E as a whole. Furthermore, 10 to 20 mass % is more preferable. If the amount is smaller than the range, enough conductivity cannot be ensured so that cycle performance becomes inferior. If larger than the range, a large discharge capacity cannot be obtained.

For the carbon to be coated, from highly-crystalline graphite through low-crystalline carbon can be used. Among these carbons, low-crystalline graphite is preferably used.

Examples of Carbon Material D present in Material E in which particles composed of a mixture of Silicon-Containing Material A and Carbon Material D have Conductive Material B, include natural graphite, artificial graphite, acetylene black, ketjen black and vapor growth carbon fiber. Various forms such as globular, fibrous and scaly can be used as appropriate. Among the examples, scaly graphite with a number average particle diameter of 1 to 15 μm is preferably contained because enough conductivity can be ensured therewith. If the diameter is smaller than the range, enough conductivity cannot be ensured. If larger than the range, it becomes difficult to form the particles.

In Material E in which particles composed of a mixture of Silicon-Containing Material A and Carbon Material D have Conductive Material B, the content of Material A is preferably 10 to 70 mass % relative to the mass of Material E as a whole. Furthermore, 10 to 30 mass % is more preferable. If the content is smaller than the range, a large discharge capacity cannot be obtained. If larger than the range, cycle performance becomes inferior.

The number average particle diameter of Material E is preferably 1 to 30 μg. If the average particle diameter is smaller than the range, Material E becomes difficult to manufacture and handle. If the average particle diameter is larger than the range, it becomes difficult to prepare a negative electrode plate.

Silicon-containing Material A, Material C and Material E can be used independently or by mixing with Carbon Material F. In this case, the proportion of the amount of Material A relative to the total amount of Material A and Carbon Material F; the proportion of the amount of Material C relative to the total amount of Material C and Carbon Material F; or the proportion of the amount of Material E relative to the total amount of Material E and Carbon Material F is preferably 1 to 30 mass %. Furthermore, 5 to 10 mass % is more preferable. If the proportion is smaller than the range, a large discharge capacity cannot be obtained. If larger than the range, cycle deterioration increases.

Examples of Carbon Material F include natural graphite, artificial graphite, acetylene black, ketjen black and vapor growth carbon fiber. These carbon materials may be used independently or by mixing two or more kinds thereof. Various forms such as globular, fibrous and scaly can be used as appropriate. Examples of the globular carbon material include meso carbon micro beads. Examples of the fibrous carbon material include mesocarbon fiber. Among these forms, scaly graphite with a number average particle diameter of 1 to 15 μg is preferably used because enough conductivity can be ensured therewith. If the diameter is smaller than the range, enough conductivity cannot be ensured. If larger than the range, the adhesiveness among particles becomes inferior.

Meso carbon micro beads, mesocarbon fiber or a material in which boron is added to these carbon materials is preferably used. The proportion of meso carbon micro beads, mesocarbon fiber or a material in which boron is added to these carbon materials, relative to the total amount of Silicon-Containing Material A and Carbon Material F; the total amount of Material C and Carbon Material F; or the total amount of Material E and Carbon Material F is preferably 5 to 40 mass %. If the proportion is smaller than the range, a large discharge capacity cannot be obtained. If larger than the range, irreversible capacity caused by boron increases.

As a binder for a negative active material, styrene-butadiene rubber (SBR), carboxymethyl-cellulose (CMC) or a mixture thereof can be used. Furthermore, another binder can be used as appropriate. Examples of another binder include poly(vinylidene fluoride), carboxy modified poly(vinylidene fluoride), polyethylene, polypropylene, poly(tetrafluoroethylene), tetrafluoroethylene-hexafluoroethylene copolymer, poly(tetrafluoroethylene-hexafluoropropylene)vinylidene fluoride-chlorotrifluoroethylene copolymer.

As a solvent or solution to be used when mixing the negative active material with the binder, a solvent or solution capable of dissolving or dispersing the binder can be used. As the solvent or solution, a nonaqueous solvent or aqueous solution can be used. Examples of the nonaqueous solvent include N-methyl-2-pyrrolidone, dimethyl formamide, dimethyl acetamide, methyl ethyl ketone, cyclohexanone, methyl acetate, methyl acrylate,-diethyl triamine, N,N dimethyl amino propyl amine, ethylene oxide and tetrahydrofuran. On the other hand, as the aqueous solution, an aqueous solution to which water, a disperser, a thickener or the like is added can be used. In the latter aqueous solution, a latex such as SBR and active material can be mixed so as to slurry them.

As a current collector of the negative electrode plate, iron, copper, stainless steel or nickel can be used. Examples of the form thereof include sheet, foam, a sintered porous body and expanded grid. Furthermore, the current collector which has a hole of an arbitrary shape may be used as a current collector.

As positive active material, various materials can be used as appropriate without any specific limitation. For example, the following compounds can be used: a transition metal compound such as manganese dioxide and vanadium pentoxide; a transition metal chalcogenide such as iron sulfide and titanium sulfide; a composite oxide LiₓMO_{2-δ} of these transition metals and lithium (M means Co, Ni or Mn; a composite oxide in which 0.4≦x≦1.2 and 0≦δ≦0.5); or a compound in which these composites oxide contain at least one element selected from Al, Mn, Fe, Ni, Co, Cr, Ti and Zn; or a compound including a nonmetallic element such as P and B. Furthermore, a composite oxide of lithium and nickel, specifically the positive active material represented by LiₓNiₚM¹_{q}M²ᵣO_{2-δ} (M¹ and M² mean at least one element selected from Al, Mn, Fe, Ni, Co, Cr, Ti and Zn; a nonmetallic element such as P and B is also available; 0.4≦x≦1.2, 0.8≦p+q+r≦1.2, and 0≦δ<0.5) or the like can be used. Among these composites oxide, a lithium-cobalt composite oxide and a lithium-cobalt-nickel composite oxide are preferable.

As a binder used for a positive electrode, a known binder can be used as appropriate without any specific limitation. For example, poly(vinylidene fluoride), polyvinylidene fluoride-hexafluoropropylene copolymer, poly(tetrafluoroethylene), fluorinated polyvinylidene fluoride, ethylene-propylene-diene terpolymer, styrene-butadiene rubber, acrylonitrile-butadiene rubber, fluororubber, polyvinyl acetate, poly-methyl methacrylate, polyethylene, nitrocellulose and the derivatives thereof can be used independently or mixing two or more kinds thereof.

As an organic solvent used for the nonaqueous electrolyte solution, a nonaqueous solvent such as ethylene carbonate, propylene carbonate, butylene carbonate, trifluoro propylene carbonate, gamma-butyrolactone, sulfolane, 1,2-dimethoxyethane, 1,2-diethoxyethane, tetrahydrofuran, 2-methyl tetrahydrofuran, 3-methyl-1,3-dioxolane, methyl acetate, ethyl acetate, methyl propionate, ethyl propionate, dimethyl carbonate, diethyl carbonate, ethyl methyl carbonate, dipropyl carbonate, methyl propyl carbonate independently or a solvent by mixing two or more kinds thereof can be used.

The nonaqueous electrolyte solution may contain a carbonate-based compound such as vinylene carbonate and butylene carbonate; a benzene-based compound such as biphenyl and cyclohexyl benzene; or a sulfur-based compound such as propane sultone independently or by mixing two or more kinds thereof.

In the present invention, as a salt to be dissolved in the organic solvent, lithium salt is preferably used. Examples of lithium salt include salts such as LiPF₆, LiClO₄, LiBF₄, LiAsF₆, LiCF(CF₃)₅, LiCF₂(CF₃ )₄, LiCF₃(CF₃)₃, LiCF₄(CF₃)₂, LiCF₅(CF₃), LiCF₃(C₂F₅)₃, LiCF₃SO₃, LiN(SO₂ CF₃ )₂, LiN(SO₂CF₂CF₃)₂, LiN(COCF₃)₂, LiN(COCF₂CF₃)₂ and a mixture thereof. Among these lithium salts, LiPF₆ is preferably used. Furthermore, the concentration of the lithium salts is preferably 0.5 to 2.0 mol/l.

In the present invention, a particularly remarkable effect can be obtained when a compound including fluorine is contained in the nonaqueous electrolyte solution. Furthermore, in the present invention, a particularly remarkable effect can be obtained when LiPF₆ is used as the salt to be dissolved in the nonaqueous electrolyte solution.

As a separator for the nonaqueous electrolyte battery according to the present invention, woven cloth, nonwoven cloth, synthetic resin microporous film or the like can be used, and the synthetic resin microporous film is particularly preferable. Examples of the material thereof include nylon, cellulose acetate, nitrocellulose, polysulfone, polyacrylonitrile and poly(vinylidene fluoride), and polyolefins such as polypropylene, polyethylene and polybutene. Among these materials, polyolefin-based microporous films such as polyethylene/polypropylene microporous films and microporous film in combination thereof are preferable in thickness, strength and resistance.

The shape of the battery is not limited to a specific one. The present invention is applicable to nonaqueous electrolyte batteries of various shapes such as prismatic, elliptic type, coin type, button type, sheet type, cylindrical and long-cylindrical batteries.

### EXAMPLES

Hereinafter, a description is given in detail for the nonaqueous electrolyte battery according to the present invention which suppresses the swelling of the nonaqueous electrolyte battery when left under high temperature conditions, with reference to the following Examples. The present invention, however, is not limited to the Examples.

### Examples 1 to 8 and Comparative Example 1

### Example 1

As the silicon-containing material to be included in the negative electrode, SiO powder including both phases of Si and SiOₓ (1<x≦2) was used (this is set to a1).

As a negative active material, the material in which a1 powder of 5 mass %; meso carbon micro beads of 40 mass %, natural graphite of 35 mass % and artificial graphite of 20 mass % as Carbon Material D had been mixed, was used. The mixed negative active material of 97 mass %, styrene-butadiene rubber (SBR) of 2 mass % and carboxymethyl-cellulose (CMC) of 1 mass % were dispersed in water so as to prepare a negative electrode mixture paste. The negative electrode mixture paste was applied onto a copper foil leaf 15 μg thick so that the amount of the negative active material accommodated in the battery would be 2 g, followed by drying at a temperature of 150° C. so as to evaporate water. The operation was performed on both sides of the copper foil leaf, followed by forming both sides by compression using a roll press machine. A negative electrode plate having a negative electrode mixture layer on both sides was thus prepared.

Next, lithium cobalt oxide of 90 mass %, acetylene black of 5 mass % and poly(vinylidene fluoride)(PVdF) of 5 mass % were dispersed in NMP so as to prepare a paste. The paste was applied onto an aluminum foil leaf 20 μm thick so that the amount of the positive active material accommodated in the battery would be 5.3 g, followed by drying at a temperature of 150° C. so as to evaporate NMP. The above operation was performed on both sides of the aluminum foil leaf, followed by forming both sides by compression using a roll press machine. A positive plate having a positive composite layer on both sides was thus prepared.

The positive and negative electrode plates thus prepared were wound by superimposing on each other through a polyethylene separator which is an open-cell porous body 20 μm thick with a porosity of 40%, and then inserted into a container 48 mm high, 30 mm wide and 5.2 mm thick so as to assemble a prismatic cell. Eventually, nonaqueous electrolyte solution was injected into the battery so as to obtain a battery for Example 1.

Next, LiPF₆ of 1 mol/l was dissolved in a solvent obtained by mixing ethylene carbonate (EC) with ethyl methyl carbonate (EMC) at a volume ratio of 3:7 so as to prepare an electrolyte solution. Then, a nonaqueous electrolyte solution obtained by mixing the electrolyte solution of 99.9 mass % with a cyclic phosphazene derivative in which n=3; one of Rs is a trifluoroethoxy group and five thereof are fluorine (this is set to K1), in Chemical Formula 2, of 0.1 mass %, was used. The proportion of K1 relative to the mass of the electrolyte solution as a whole was 0.1 mass %.

### Example 2

A battery was prepared as Example 2 similarly to Example 1 except that the proportion of K1 relative to the mass of the electrolyte solution as a whole was 1 mass %.

### Example 3

A battery was prepared as Example 3 similarly to Example 1 except that the proportion of K1 relative to the mass of the electrolyte solution as a whole was 10 mass %.

### Example 4

A battery was prepared as Example 4 similarly to Example 1 except that the proportion of K1 relative to the mass of the electrolyte solution as a whole was 20 mass %.

### Example 5

A battery was prepared as Example 5 similarly to Example 1 except that the proportion of K1 relative to the mass of the electrolyte solution as a whole was 30 mass %.

### Example 6

A battery was prepared as Example 6 similarly to Example 1 except that the proportion of K1 relative to the mass of the electrolyte solution as a whole was 40 mass %.

### Example 7

A battery was prepared as Example 7 similarly to Example 1 except that the proportion of K1 relative to the mass of the electrolyte solution as a whole was 60 mass %.

### Example 8

A battery was prepared as Example 8 similarly to Example 1 except that the proportion of K1 relative to the mass of the electrolyte solution as a whole was 80 mass %.

### Comparative Example 1

A battery was prepared as Comparative Example 1 similarly to Example 1 except that LiPF₆ of 1 mol/l was dissolved in a solvent obtained by mixing ethylene carbonate (EC) with ethyl methyl carbonate (EMC) at a volume ratio of 3:7 as a nonaqueous electrolyte solution.

For the batteries of Examples 1 to 8 and Comparative Example 1, charge/discharge characteristics were measured under the following conditions. At 25° C., each battery was charged with a constant current of 650 mA up to 4.2 V and then charged at a constant voltage of 4.2 V for two hours, followed by being stored in a thermostatic chamber at 80° C. for five days. After five days, each battery was taken out of the thermostatic chamber and cooled naturally down to 25° C., and the thickness thereof was then measured. Table 1 shows details on the batteries and the thicknesses thereof measured after storing at 80° C. for five days. In all the batteries shown in Table 1, a1 was used as silicon-containing material; the mixed proportion of the silicon-containing material included in the negative active material was 5 mass %; and K1 was used as phosphazene.

TABLE 1

| | Content of phosphazene | Battery thickness, |
|---|---|---|
| | derivative K1 | at 80° C. after 5 |
| | in electrolyte solution, mass % | days, mm |
| Example 1 | 0.1 | 6.9 |
| Example 2 | 1 | 6.6 |
| Example 3 | 10 | 6.4 |
| Example 4 | 20 | 6.4 |
| Example 5 | 30 | 6.5 |
| Example 6 | 40 | 6.9 |
| Example 7 | 60 | 7.5 |
| Example 8 | 80 | 7.8 |
| Comparative | 0 | 8.2 |
| Example 1 | | |

In the comparison among Examples 1 to 8 and Comparative Example 1 shown in Table 1, in the case of Comparative Example 1 in which no phosphazene derivative was contained in the nonaqueous electrolyte solution, the battery swelled to a very large extent when left under high temperature conditions. On the other hand, in the cases of Examples 1 to 8 in which the cyclic phosphazene derivative K1 was contained in the nonaqueous electrolyte solution, the battery swelled to a smaller extent regardless of the content of the cyclic phosphazene derivative K1. The reason is considered to be due to the fact that the cyclic phosphazene derivative K1 suppresses the reaction between the nonaqueous electrolyte solution and SiO.

In Examples 1 to 8, when the amount of the cyclic phosphazene derivative K1 contained in the nonaqueous electrolyte solution was 0.1 to 60 mass % relative to the mass of the nonaqueous electrolyte solution as a whole, the battery swelled to a smaller extent when left under high temperature conditions. When 0.1 to 30 mass %, the battery swelled to a further smaller extent.

Therefore, in the nonaqueous electrolyte battery which uses the negative electrode including SiO, where the nonaqueous electrolyte solution contains the cyclic phosphazene derivative K1, in order to suppress the swelling of the battery when left under high temperature conditions, the amount of the cyclic phosphazene derivative K1 relative to the mass of the nonaqueous electrolyte solution as a whole is preferably 0.1 to 60 mass %, and more preferably 0.1 to 30 mass %.

### Examples 9 to 16

### Example 9

A battery was prepared as Example 9 similarly to Example 1 except that a nonaqueous electrolyte solution obtaining by mixing the following, was used: a nonaqueous electrolyte solution of 99.9 mass % in which LiPF₆ of 1 mol/l was dissolved in a solvent obtained by mixing ethylene carbonate (EC) and ethyl methyl carbonate (EMC) at a volume ratio of 3:7; and a cyclic phosphazene derivative K2 of 0.1 mass % in which n=3; two of Rs are trifluoroethoxy groups and four thereof are fluorine, in Chemical Formula 2. The proportion of K2 relative to the mass of the electrolyte solution as a whole was 0.1 mass %.

### Example 10

A battery was prepared as Example 10 similarly to Example 2 except that the proportion of K2 relative to the mass of the electrolyte solution as a whole was 1 mass %.

### Example 11

A battery was prepared as Example 11 similarly to Example 2 except that the proportion of K2 relative to the mass of the electrolyte solution as a whole was 10 mass %.

### Example 12

A battery was prepared as Example 12 similarly to Example 2 except that the proportion of K2 relative to the mass of the electrolyte solution as a whole was 20 mass %.

### Example 13

A battery was prepared as Example 13 similarly to Example 2 except that the proportion of K2 relative to the mass of the electrolyte solution as a whole was 30 mass %.

### Example 14

A battery was prepared as Example 14 similarly to Example 2 except that the proportion of K2 relative to the mass of the electrolyte solution as a whole was 40 mass %.

### Example 15

A battery was prepared as Example 15 similarly to Example 2 except that the proportion of K2 relative to the mass of the electrolyte solution as a whole was 60 mass %.

### Example 16

A battery was prepared as Example 16 similarly to Example 2 except that the proportion of K2 relative to the mass of the electrolyte solution as a whole was 80 mass %.

For the batteries of Examples 9 to 16, charge/discharge characteristics and the thicknesses after storing at 80° C. for five days were measured under the same conditions as in Example 1. Table 2 shows details on the batteries and the thicknesses thereof measured after storing at 80° C. for five days. In all the batteries shown in Table 2, a1 was used as silicon-containing material; the mixed proportion of the silicon-containing material included in the negative active material was 5 mass %; and K2 was used as a phosphazene derivative. It should be noted that the data of Comparative Example 1 is also shown in Table 2 for comparison.

TABLE 2

| | Content of phosphazene | Battery thickness, |
|---|---|---|
| | derivative K2 | at 80° C. after 5 |
| | in electrolyte solution, mass % | days, mm |
| Example 9 | 0.1 | 6.9 |
| Example 10 | 1 | 6.7 |
| Example 11 | 10 | 6.6 |
| Example 12 | 20 | 6.4 |
| Example 13 | 30 | 6.4 |
| Example 14 | 40 | 6.8 |
| Example 15 | 60 | 7.3 |
| Example 16 | 80 | 7.7 |
| Comparative | 0 | 8.2 |
| Example 1 | | |

Also in Examples 9 to 16 and Comparative Example 1 shown in Table 2, compared with Comparative Example 1 in which no phosphazene derivative was included in the nonaqueous electrolyte solution, the battery swelled to a smaller extent regardless of the content of the cyclic phosphazene derivative K2. It is shown that the battery swelling can be suppressed when left under high temperature conditions by containing the cyclic phosphazene derivative K2 in the nonaqueous electrolyte solution.

Furthermore, when the content of the cyclic phosphazene derivative K2 was 0.1 to 60 mass % relative to the total mass of the nonaqueous electrolyte solution and the cyclic phosphazene derivative K2, the battery swelled to a smaller extent when left under high temperature conditions. When 0.1 to 30 mass %, the battery swelled to a further smaller extent.

This shows that, in the nonaqueous electrolyte battery which uses the negative electrode including SiO, where the nonaqueous electrolyte solution contains the cyclic phosphazene derivative K2, in order to suppress the swelling of the battery when left under high temperature conditions, the amount of the cyclic phosphazene derivative K2 relative to the total mass of the nonaqueous electrolyte solution and the cyclic phosphazene derivative K2 is preferably 0.1 to 60 mass %, and more preferably 0.1 to 30 mass %.

### Examples 17 to 24

### Example 17

A battery was prepared as Example 17 similarly to Example 2 except that a cyclic phosphazene derivative K3 in which n=3; one of Rs is a trifluoromethoxy group; and five thereof are fluorine, in Chemical Formula 2, was used as a cyclic phosphazene derivative.

### Example 18

A battery was prepared as Example 18 similarly to Example 2 except that a cyclic phosphazene derivative K4 in which n=3; two of Rs are trifluoromethoxy groups and four thereof are fluorine, in Chemical Formula 2, was used as a cyclic phosphazene derivative.

### Example 19

A battery was prepared as Example 19 similarly to Example 2 except that a cyclic phosphazene derivative K5 in which n=3; one of Rs is a trifluoroethoxy group; one of thereof is a trifluoromethoxy group; and four thereof are fluorine, in Chemical Formula 2 was used as a cyclic phosphazene derivative.

### Example 20

A battery was prepared as Example 20 similarly to Example 2 except that a cyclic phosphazene derivative K6 in which n=3; and all of the Rs are fluorine, in Chemical Formula 2, was used as a cyclic phosphazene derivative.

### Example 21

A battery was prepared as Example 20 similarly to Example 2 except that cyclic phosphazene derivative K7 in which n=3; and all of Rs are chlorine, in Chemical Formula 2, was used as a cyclic phosphazene derivative.

### Example 22

A battery was prepared as Example 22 similarly to-Example 2 except that a cyclic phosphazene derivative K8 in which n=3; and all of Rs are trifluoroethoxy groups, in Chemical Formula 2, was used as a cyclic phosphazene derivative.

### Example 23

A battery was prepared as Example 23 similarly to Example 2 except that a cyclic phosphazene derivative K9 in which n=4; and all of Rs are trifluoroethoxy groups, in Chemical Formula 2, was used as a cyclic phosphazene derivative.

### Example 24

A battery was prepared as Example 24 similarly to Example 2 except that a chain phosphazene derivative K10 in which n=3; one of Rs is a trifluoroethoxy group; and fives thereof are fluorine, in Chemical Formula 1, was used as a chain phosphazene derivative.

For the batteries of Examples 17 to 24, charge/discharge characteristics and the thicknesses after storing at 80° C. for five days were measured under the same conditions as in Example 2. Table 3 shows details on the batteries and the thicknesses thereof measured after storing at 80° C. for five days. In all the batteries shown in Table 3, a1 was used as silicon-containing material; the mixed proportion of the silicon-containing material included in the negative active material was 5 mass %; and the proportion of the phosphazene derivative relative to the mass of the electrolyte solution as a whole was 1 mass %. It should be noted that the data of Example 2 and Example 10 are also shown in Table 3 for comparison.

TABLE 3

| | | Battery thickness, |
|---|---|---|
| | Type of phosphazene | at 80° C. after 5 |
| | derivative | days, mm |
| Example 2 | K1 | 6.6 |
| Example 10 | K2 | 6.7 |
| Example 17 | K3 | 6.7 |
| Example 18 | K4 | 6.6 |
| Example 19 | K5 | 6.6 |
| Example 20 | K6 | 6.8 |
| Example 21 | K7 | 6.8 |
| Example 22 | K8 | 6.6 |
| Example 23 | K9 | 6.5 |
| Example 24 | K10 | 6.5 |

Also in Examples 2, 10 and 17 to 24 shown in Table 3, in which various phosphazene derivatives were contained in the nonaqueous electrolyte solution, the swelling of the battery was suppressed when left under high temperature conditions. Also, no difference was found in swelling depending on the type of the phosphazene derivative. This shows that, the phosphazene derivative contained in the nonaqueous electrolyte-solution can suppress the swelling of the battery in which the negative electrode includes SiO, when left under high temperature conditions, regardless of the battery structure.

### Examples 25 to 32 and Comparative Example 2

### Example 25

Using the same SiO powder a1 as used in Example 1, by the method in which benzene gas is decomposed by heat in an argon atmosphere at 1000° C. (CVD), a product a2 was obtained by coating the surface of a1 with carbon to be used as silicon-containing material. The amount of the supported carbon was 20 mass % relative to the total mass of a1 and the carbon. The number average particle diameter was 1 μm after the carbon was supported. A battery was prepared as Example 25 similarly to Example 1 except that the mixed negative active material of the product a2 of 5 mass %; and meso carbon micro beads of 40 mass %, natural graphite of 35 mass % and artificial graphite of 20 mass % for Carbon Material D, was used.

In Example 25, the proportion of the cyclic phosphazene derivative K1 relative to the mass of the electrolyte solution as whole was 0.1 mass %.

### Example 26

A battery was prepared as Example 26 similarly to Example 25 except that the proportion of the K1 relative to the mass of the electrolyte solution as whole was 1 mass %.

### Example 27

A battery was prepared as Example 27 similarly to Example 25 except that the proportion of the K1 relative to the mass of the electrolyte solution as a whole was 10 mass %.

### Example 28

A battery was prepared as Example 28 similarly to Example 25 except that the proportion of the K1 relative to the mass of the electrolyte solution as a whole was 20 mass %.

### Example 29

A battery was prepared as Example 29 similarly to Example 25 except that the proportion of the K1 relative to the mass of the electrolyte solution as a whole was 30 mass %.

### Example 30

A battery was prepared as Example 30 similarly to Example 25 except that the proportion of the K1 relative to the mass of the electrolyte solution as a whole was 40 mass %.

### Example 31

A battery was prepared as Example 31 similarly to Example 25 except that the proportion of the K1 relative to the mass of the electrolyte solution as a whole was 60 mass %.

### Example 32

A battery was prepared as Example 32 similarly to Example 25 except that the proportion of the K1 relative to the mass of the electrolyte solution as a whole was 80 mass %.

Comparative Example 2

A battery was prepared as Comparative Example 2 similarly to Example 25 except that no K1 was added to the electrolyte solution.

For the batteries of Examples 25 to 32 and Comparative Example 2, charge/discharge characteristics and the thickness after storing at 80° C. for five days were measured under the same conditions as in Example 1. Table 4 shows details on the batteries and the thicknesses thereof measured after storing at 80° C. for five days. In all the batteries shown in Table 4, a2 was used as silicon-containing material; the mixed proportion of the silicon-containing material included in the negative active material was 5 mass %; and K1 was used as a phosphazene derivative.

TABLE 4

| | Content of phosphazene | Battery thickness, |
|---|---|---|
| | derivative K1 | at 80° C. after 5 |
| | in electrolyte solution, mass % | days, mm |
| Example 25 | 0.1 | 6.6 |
| Example 26 | 1 | 6.2 |
| Example 27 | 10 | 6.1 |
| Example 28 | 20 | 6.2 |
| Example 29 | 30 | 6.2 |
| Example 30 | 40 | 6.6 |
| Example 31 | 60 | 6.9 |
| Example 32 | 80 | 7.3 |
| Comparative | 0 | 8.1 |
| Example 2 | | |

Regarding Examples 25 to 32 and Comparative Example 2 shown in Table 4, in the case of Comparative Example 2 in which the product a2 obtained by supporting carbon on the surface of a1 was contained in the negative active material and no phosphazene derivative was contained in the nonaqueous electrolyte solution, the battery swelled to a very large extent when left under high temperature conditions. On the other hand, in the cases of Examples 25 to 32 in which the phosphazene derivative K1 was contained in the nonaqueous electrolyte solution, the battery swelled to a smaller extent regardless of the content of the phosphazene derivative K1. The reason therefore is considered to be due to the fact that the phosphazene derivative K1 suppresses the reaction between the nonaqueous electrolyte solution and SiO.

In Examples 25 to 32, when the amount of the phosphazene derivative K1 contained in the nonaqueous electrolyte solution was 0.1 to 60 mass % relative to the total mass of the nonaqueous electrolyte solution and the phosphazene derivative, the battery swelled to a smaller extent when left under high temperature conditions. When 0.1 to 30 mass %, the battery swelled to a further smaller extent. This is the same tendency as found in Examples 1 to 8 in which a1 was contained in the negative electrode.

This shows that, in the nonaqueous electrolyte battery which uses the negative electrode including the product a2 in which carbon was supported on the surface of a1 in the negative active material, by the method in which SiO powder a1 is decomposed by heat in an argon atmosphere using benzene gas at 1000° C. (CVD), in which the phosphazene derivative was contained in the nonaqueous electrolyte solution, in order to suppress the swelling of the battery when left under high temperature conditions, the amount of the phosphazene derivative relative to the total mass of the nonaqueous electrolyte solution and the phosphazene derivative is preferably 0.1 to 60 mass %, and more preferably 0.1 to 30 mass %.

### Examples 33 to 36 and Comparative Examples 3 to 6

### Example 33

A battery was prepared as Example 33 similarly to Example 3 except that the mixed negative active material of the SiO powder a1 used in Example 3 of 10 mass %; meso carbon micro beads of 40 mass %, natural graphite of 30 mass % and rtificial graphite of 20 mass % as Carbon Material D, was used.

### Comparative Example 3

A battery was prepared as Comparative Example 3 similarly to Example 33 except that an electrolyte solution in which the cyclic phosphazene derivative K1 was not contained, was used.

### Example 34

A battery was prepared as Example 34 similarly to Example 3 except that the mixed negative active material of the SiO powder a1 used in Example 3 of 15 mass %; meso carbon micro beads of 40 mass %, natural graphite of 25 mass % and artificial graphite of 20 mass % as Carbon Material D, was used.

### Comparative Example 4

A battery was prepared as Comparative Example 4 similarly to Example 34 except that an electrolyte solution in which the cyclic phosphazene derivative K1 was not contained, was used.

### Example 35

A battery was prepared as Example 35 similarly to Example 27 except that the mixed negative active material of the product a2 used in Example 27 of 10 mass %; meso carbon micro beads of 40 mass %, natural graphite of 30 mass % and artificial graphite of 20 mass % as Carbon Material D, was used.

### Comparative Example 5

A battery was prepared as Comparative Example 5 similarly to Example 35 except that an electrolyte solution in which the cyclic phosphazene derivative K1 was not contained, was used.

### Example 36

A battery was prepared as Example 36 similarly to Example 27 except that the mixed negative active material of the product a2 used in Example 27 of 15 mass %; meso carbon micro beads of 40 mass %, natural graphite of 25 mass % and artificial graphite of 20 mass % as Carbon Material D, was used.

### Comparative Example 6

A battery was prepared as Comparative Example 6 similarly to Example 36 except that an electrolyte solution in which the cyclic phosphazene derivative K1 was not contained, was used.

For the batteries of Examples 33 to 36 and Comparative Examples 3 to 6, charge/discharge characteristics and the thickness after storing at 80° C. for five days were measured under the same conditions as in Example 1. Table 5 shows details on the batteries and the thicknesses thereof measured after storing at 80° C. for five days. In all the batteries shown in Table 5, K1 was used as a phosphazene derivative; and the proportion of K1 relative to the mass of the electrolyte solution as a whole was 10 mass %. It should be noted that the data of Examples 3 and 27, and Comparative Examples 1 and 2 are also shown in Table 5 for comparison.

TABLE 5

| | | Mixed proportion of | | |
|---|---|---|---|---|
| | Type of | silicon-containing | | |
| | silicon- | material contained in | Content of phosphazene | Battery thickness, |
| | containing | negative active | derivative K1 | at 80° C. after 5 |
| | material | material, mass % | in electrolyte solution, mass % | days, mm |
| Example 3 | a1 | 5 | 10 | 6.4 |
| Example 33 | a1 | 10 | 10 | 6.8 |
| Example 34 | a1 | 15 | 10 | 7.3 |
| Example 27 | a2 | 5 | 10 | 6.1 |
| Example 35 | a2 | 10 | 10 | 6.2 |
| Example 36 | a2 | 15 | 10 | 6.5 |
| Comparative | a1 | 5 | 0 | 8.2 |
| Example 1 | | | | |
| Comparative | a1 | 10 | 0 | 8.5 |
| Example 3 | | | | |
| Comparative | a1 | 15 | 0 | 8.7 |
| Example 4 | | | | |
| Comparative | a2 | 5 | 0 | 8.1 |
| Example 2 | | | | |
| Comparative | a2 | 10 | 0 | 8.4 |
| Example 5 | | | | |
| Comparative | a2 | 15 | 0 | 8.5 |
| Example 6 | | | | |

From Table 5, when using the mixed negative active material of the SiO powder a1 and Carbon Material D, if comparison is made among Examples 3, 33 and 34, and Comparative Examples 1, 3 and 4 which varied in the mixed proportion of the SiO powder a1 and Carbon Material D, it is shows that the battery swelling can be suppressed when left under high temperature conditions by containing the phosphazene derivative in the nonaqueous electrolyte solution even when the mixed proportion of the SiO powder a1 increased. Also, when using the mixed negative active material of the product a2 and Carbon Material D, if comparison is made among Examples 27, 35 and 36, and Comparative Examples 2, 5 and 6 which varied in the mixed proportion of the product a2 and Carbon Material D, it is shown that the battery swelling can be suppressed when left under high temperature conditions by containing the phosphazene derivative in the nonaqueous electrolyte solution also when the mixed proportion of the product a1 increases.

If comparison is made between Examples 3, 33 and 34 in which the SiO powder a1 was used as silicon-containing material; and Examples 27, 35 and 36 in which the product a2 obtained by coating the surface of the SiO powder a1 with carbon, it is shown that the battery swelling can be suppressed significantly when left under high temperature conditions if using the product a2. It is also shown that the battery swelling can be suppressed effectively when left under high temperature conditions particularly if the phosphazene derivative is contained in the nonaqueous electrolyte solution. The reason, which remains unclear, is considered to be due to the fact that the supported carbon increased the specific surface area of the product, thereby increasing the reaction area between the combined particles and the phosphazene derivative.

When the silicon-containing material is coated with carbon as described above, the battery swelling can be suppressed more significantly than a case in which not coated with carbon, which is similarly valid not only for the case in which K1 was used as a phosphazene derivative, but also for the case in which any of K2, K3, K4, K5, K6, K7, K8, K9 and K10 was used. Since all the phosphazene derivatives with which the experiments had carried out thus had an identical effect, it is understood that other phosphazene derivatives represented by Chemical Formula 1 and Chemical Formula 2 can have an identical effect as a matter of course.

Furthermore, when the silicon-containing material is coated with carbon as described above, the battery swelling can be suppressed more significantly than in a case in which not coated with carbon, which is similarly valid not only for the case in which CVD was used for coating the silicon-containing material with carbon, but also for both methods in which mechanochemical reaction is used and in which a mixture of thermoplastic resin and silicon-containing material is calcinated.

Furthermore, when the silicon-containing material is coated with carbon as described above, the battery swelling can be suppressed more significantly than in a case in which not coated with carbon, which is similarly valid not only for the case in which SiO was used as silicon-containing material, but also for any of the cases in which Si, Si₃N₄, SiS₂ and ZnSi₂ were used. Since all the silicon-containing materials with which the experiments had carried out thus had an identical effect, it is understood that silicon-containing materials other than the foregoing silicon-containing materials can have an identical effect as a matter of course.

Furthermore, when the silicon-containing material is coated with carbon as described above, the battery swelling can be suppressed more significantly than in a case in which not coated with carbon, which is similarly valid not only for the case in which the content of the phosphazene derivative in the electrolyte solution is 10 mass %, but also for the cases of 0.1 mass % and 30 mass %.

### Examples 37 to 43

### Example 37

The SiO particles a1 and scaly graphite with an average particle diameter of 10 μg were mixed at a mass ratio of 50:50 and changed into combined particles using a ball-milling machine, followed by supporting carbon on the surface of the combined particles by the method in which benzene gas is decomposed by heat in an argon atmosphere at 1000° C. (CVD), so as to obtain a product a3 to be used as silicon-containing material. The amount of the supported carbon was 20 mass % relative to the total mass of the combined particles and the carbon. The number average particle diameter was 20 μg after the carbon was supported. A battery was prepared as Example 37 similarly to Example 2 except that the mixed negative active material of the product a3 of 5 mass %; and meso carbon micro beads of 40 mass %, natural graphite of 35 mass %, and artificial graphite of 20 mass % as Carbon Material D, was used.

### Example 38

A battery was prepared as Example 38 similarly to Example 2 except that Si particles a4 was used as silicon-containing material.

### Example 39

Using the same Si powder a4 as in Example 38, by the method in which benzene gas is decomposed by heat in an argon atmosphere at 1000° C. (CVD), a product a5 in which carbon was supported on the surface of the Si particles a4 was obtained to be used as silicon-containing material. The amount of the supported carbon was 20 mass % relative to the total mass of the a4 and the carbon. The number average particle diameter was 1 μg after the carbon was supported. A battery was prepared as Example 39 similarly to Example 2 except that the mixed negative active material of the product a5 of 5 mass %; and meso carbon micro beads of 40 mass %, natural graphite of 35 mass % and artificial graphite of 20 mass % as Carbon Material D, was used.

### Example 40

The Si particles a4 and scaly graphite with an average particle diameter of 10 μm were mixed at a mass ratio of 50:50 and changed into combined particles using a ball-milling machine, followed by supporting carbon on the surface of the combined particles by the method in which benzene gas is decomposed by heat in an argon atmosphere at 1000° C. (CVD), so as to obtain a product a6 to be used as silicon-containing material. The amount of the supported carbon was 20 mass % relative to the total mass of the combined particles and the carbon. The number average particle diameter was 20 μm after the carbon was supported. A battery was prepared as Example 40 similarly to Example 2 except that the mixed negative active material of the product a6 of 5 mass %; and meso carbon micro beads of 40 mass %, natural graphite of 35 mass %, and artificial graphite of 20 mass % as Carbon Material D, was used.

For the batteries of Examples 37 to 40, charge/discharge characteristics and the thickness after storing at 80° C. for five days were measured under the same conditions as in Example 1. Table 6 shows details on the batteries and the thicknesses thereof measured after storing at 80° C. for five days. In all the batteries shown in Table 6, the mixed proportion of the silicon-containing material contained in the negative active material was 5 mass %; K1 is used as a phosphazene derivative; and the proportion of K1 relative to the mass of the electrolyte solution as a whole was 10 mass %.

TABLE 6

| | Type of Silicon- | Battery thickness, |
|---|---|---|
| | Containing | at 80° C. after 5 |
| | Material A | days, mm |
| Example 2 | a1 | 6.6 |
| Example 26 | a2 | 6.2 |
| Example 37 | a3 | 6.1 |
| Example 38 | a4 | 6.7 |
| Example 39 | a5 | 6.4 |
| Example 40 | a6 | 6.3 |

From Table 6, in Examples 2, 26 and 37 to 40, when any of the materials was used as silicon-containing material, the battery swelling was effectively suppressed when left under high temperature conditions, by containing the phosphazene derivative in the nonaqueous electrolyte solution. The reason, which remains unclear, is considered to be due to the fact that the phosphazene derivative reacts with silicon to form a stable film thereby suppressing the reaction of the halogen element and the silicon present in the nonaqueous electrolyte solution. When the negative electrode was taken out of each battery described in the above Examples so as to analyze the components of the film formed on the surface of the negative electrode, N element and P element were detected.

Although the present invention has been described in detail with reference to the specific examples, it should be understood by those skilled in the art that various changes and modifications may be made therein without deviating from the spirit and scope of the present invention.

This application is based on the Japanese Patent Application No. 2003-348134 filed on Oct. 7th, 2003. The entire disclosure of the specification is incorporated herein by reference.

### INDUSTRIAL APPLICABILITY

The nonaqueous electrolyte secondary battery according to the present invention is characterized by having a negative electrode including silicon-containing material, in which the nonaqueous electrolyte solution includes a phosphazene derivative. Thanks to the present invention, in the nonaqueous electrolyte secondary battery which uses the negative electrode including silicon-containing material, the swelling of the battery can be suppressed when left under high temperature conditions.

1. A nonaqueous electrolyte secondary battery which comprises a negative electrode including silicon-containing material, wherein:
said battery comprises a nonaqueous electrolyte solution, and said nonaqueous electrolyte solution includes a phosphazene derivative.

2. The nonaqueous electrolyte secondary battery according to claim 1, wherein said silicon-containing material is coated with carbon.

3. The nonaqueous electrolyte secondary battery according to claim 1, wherein a concentration of said phosphazene derivative is 0.1 to 30 mass % relative to said nonaqueous electrolyte solution.

4. The nonaqueous electrolyte secondary battery according to claim 1, wherein said silicon-containing material is either one of silicon and a silicon oxide.

5. The nonaqueous electrolyte secondary battery according to claim 2, wherein said silicon-containing material is coated with carbon by at least one of following methods:
a method of CVD;
a method using mechanochemical reaction; and
a method in which a mixture of thermoplastic resin and silicon-containing material is calcinated.

6. The nonaqueous electrolyte secondary battery according to claim 2, wherein a mixed proportion of said silicon-containing material relative to a negative active material which said negative electrode has is 5 to 15 mass %.

7. The nonaqueous electrolyte secondary battery according to claim 2, wherein said silicon-containing material coated with carbon and said silicon-containing material mixed with carbon material are included in the negative electrode.

8. The nonaqueous electrolyte secondary battery according to claim 2, wherein a concentration of said phosphazene derivative is 0.1 to 30 mass % relative to said nonaqueous electrolyte solution.

9. The nonaqueous electrolyte secondary battery according to claim 2, wherein said silicon-containing material is either one of silicon and a silicon oxide.

10. The nonaqueous electrolyte secondary battery according to claim 1, wherein said nonaqueous electrolyte solution includes a compound including fluorine.

11. The nonaqueous electrolyte secondary battery according to claim 2, wherein said nonaqueous electrolyte solution includes a compound including fluorine.

12. The nonaqueous electrolyte secondary battery according to claim 10, wherein said compound is LiPF₆.

13. The nonaqueous electrolyte secondary battery according to claim 11, wherein said compound is LiPF₆.
